(19) United States
(12) Patent Application Publication
(10) Pub. No.: US 2015/0058065 A1
(43) Pub. Date: Feb. 26, 2015

(54) GENERATING WORK PLANS USING SUBSTITUTE CONSTITUENTS

(71) Applicant: International Business Machines Corporation, Armonk, NY (US)

(72) Inventors: Florian Pinel, New York, NY (US); Lav R. Varshney, Yorktown Heights, NY (US)

(73) Assignee: International Business Machines Corporation, Armonk, NY (US)

(21) Appl. No.: 13/972,232

(22) Filed: Aug. 21, 2013

(51) Int. Cl. G06Q 10/06

(52) U.S. Cl. CPC G06Q 10/06315
USPC 705/7.25

(57) ABSTRACT

A method comprises evaluating a first work plan comprising one or more constituents to determine a first set of work plan metrics, determining one or more constraints for constituents of the first work plan, selecting one or more substitute constituents to replace constituents of the first work plan based at least in part on the determined constraints and the determined work plan metrics and generating a second work plan using the substitute constituents, the second work plan having a second set of work plan metrics similar to the first set of work plan metrics. The evaluating, determining, selecting and generating are performed by at least one processing device.

### FIELD

The field relates to computational creativity and, more particular to techniques for generation of work products.

### BACKGROUND

Computer programs and other machinery can be utilized for fabricating material and abstract objects. Such computer programs and machinery use work plans, or a process that realizes a work product, to facilitate the fabrication of material and abstract objects. Material objects include, by way of example, manufactured goods such as electronic circuits, food products, pharmaceuticals, etc. Abstract objects include, by way of example, complex travel itineraries, financial portfolios, culinary recipes, etc. Fabrication of existing work products is or can be automated or facilitated by computer programs, but the creation of new work products and the development of new work plans are not automated.

### SUMMARY

According to one embodiment of the invention, a method comprises evaluating a first work plan comprising one or more constituents to determine a first set of work plan metrics, determining one or more constraints for constituents of the first work plan, selecting one or more substitute constituents to replace constituents of the first work plan based at least in part on the determined constraints and the determined work plan metrics and generating a second work plan using the substitute constituents, the second work plan having a second set of work plan metrics similar to the first set of work plan metrics. The evaluating, determining, selecting and generating are performed by at least one processing device.

According to another embodiment of the invention, an article of manufacture comprises a computer readable storage medium for storing computer readable program code. The computer readable program code, when executed, causes a computer to evaluate a first work plan comprising one or more constituents to determine a first set of work plan metrics, determine one or more constraints for constituents of the first work plan, select one or more substitute constituents to replace constituents of the first work plan based at least in part on the determined constraints and the determined work plan metrics, and generate a second work plan using the substitute constituents, the second work plan having a second set of work plan metrics similar to the first set of work plan metrics.

According to another embodiment of the invention, an apparatus comprises a memory and a processor device operatively coupled to the memory. The processor device is configured to evaluate a first work plan comprising one or more constituents to determine a first set of work plan metrics, determine one or more constraints for constituents of the first work plan, select one or more substitute constituents to replace constituents of the first work plan based at least in part on the determined constraints and the determined work plan metrics, and generate a second work plan using the substitute constituents, the second work plan having a second set of work plan metrics similar to the first set of work plan metrics.

These and other embodiments of the invention will become apparent from the following detailed description of illustrative embodiments thereof, which is to be read in connection with the accompanying drawings.

### BRIEF DESCRIPTION OF THE SEVERAL VIEWS OF THE DRAWINGS

FIG. 1 illustrates a system for work plan analysis and generation, according to an embodiment of the invention.

FIG. 2 illustrates a system for recipe analysis and generation, according to an embodiment of the invention.

FIG. 3 illustrates a system for itinerary analysis and generation, according to an embodiment of the invention.

FIG. 4 illustrates a three-dimensional metric space, according to an embodiment of the invention.

FIG. 5 illustrates a three-dimensional recipe metric space, according to an embodiment of the invention.

FIG. 6 illustrates an example of ingredient classifications, according to an embodiment of the invention.

FIG. 7 illustrates an example of recipe classifications, according to an embodiment of the invention.

FIG. 8 illustrates an example of constituent substitution for a work plan, according to an embodiment of the invention.

FIG. 9 illustrates another example of constituent substation for a work plan, according to an embodiment of the invention.

FIG. 10 illustrates a further example of constituent substitution for a work plan, according to an embodiment of the invention.

FIG. 11 illustrates an example of ingredient substitution for a recipe, according to an embodiment of the invention.

FIG. 12 illustrates a methodology for determining a recipe with ingredient substitutes, according to an embodiment of the invention.

FIG. 13 illustrates a methodology for determining ingredient substitutes, according to an embodiment of the invention.

FIG. 14 illustrates a computing device in accordance with which one or more components/steps of techniques of the invention may be implemented, according to an embodiment of the invention.

### DETAILED DESCRIPTION

Illustrative embodiments of the invention may be described herein in the context of illustrative methods, systems and devices for the generation of work plans. However, it is to be understood that embodiments of the invention are not limited to the illustrative methods, systems and devices described but instead are more broadly applicable to other suitable methods, systems and devices.

Embodiments of the invention are described herein in the context of generation of new work plans. It is to be appreciated, however, that the term “work plan” should be broadly construed. For example, a recipe may be considered a work plan that realizes a particular work product such as a food dish. The recipe itself, however, may also be considered a work plan. Thus, the terms work plan and work product as used herein are not mutually exclusive to one another.

Various types of work plans and processes may be utilized in a variety of contexts. By way of example, work plans may include culinary recipes, travel itineraries, business plans, etc. In some instances, constraints can make the use of existing work plans impossible, impractical or undesirable. For example, food-borne diseases, ingredient costs, ingredient shortages, preference shifts, medical conditions, etc. can render an existing work plan such as a recipe obsolete or impractical for a given situation. Similarly, constraints such as weather, event closures, security and other travel restrictions, etc. can render an existing travel itinerary unusable. Various other constraints may affect the viability of work plans in other contexts.

Constraints may be due to a variety of dynamic causes and events. By way of example, in the case of an E. coli outbreak, new information about potentially contaminated products can arrive on a daily basis for a period of several weeks or months. Consumers and food preparers may desire to use an existing recipe for a preferred food dish, but modify the ingredients for the recipe to accommodate various constraints while preserving flavor, integrity and quality.

Examples of constraints in the context of recipes, as discussed above, may include food-borne disease outbreaks, ingredient cost and availability changes, preference changes and health changes. By way of example, a food-borne disease outbreak may include outbreaks of E. coli, salmonella, etc. Often, such diseases may be linked to a particular type of food product or ingredient. Ingredient cost and availability changes may be due to a variety of factors. For example, weather events such as storms, droughts, etc. may cause crop failure or disruption of shipping lines. Preference changes can be due to particular ingredients going in and out of fashion. Preference changes may also results from a consumer desire to use locally-grown ingredients or organic foods, etc. Health changes may be influenced by new medical studies regarding the health and safety of particular ingredients for dietary purposes. Preference and health changes may also be due to factors specific to a particular individual. For example, a consumer may wish to use an existing recipe, but modify it due to a food allergy or other dietary constraint.

Embodiments of the invention allow for the generation of new work plans. Given an existing work plan, embodiments can generate new work plans subject to various constraints. New work plans may be generated such that they retain one or more desired characteristics or metrics of the existing work plan. Substitute constituents may be selected such that a new work plan and the existing work plan have substantially similar metrics or characteristics.

FIG. 1 illustrates a system 100 for work plan analysis and generation. The system includes a designer module 102, evaluator module 104, constraint modules 106-1 to 106-N and a domain knowledge database 108. Designer module 102 is configured to receive an existing work plan and information relating to one or more constraints from the constraint modules 106. Each of the constraint modules 106 may be associated with a different category or class of constraints or with different information sources. A given one of the constraint modules 106 may also be associated with two or more categories or classes of constraints, or two or more of the constraint modules 106 may be associated with a single category or class of constraints.

The designer module 102 is also configured to communicate with a domain knowledge database 108. The domain knowledge database 108 may store information relating to one or more work plans and constituents. The information relating to the work products and plans can be utilized to cluster the work products and plans based on various classifications and evaluating generated work plans, as will be described in further detail below. Constituent information may include information relating to cost, composition, etc. For example, in the context of recipe generation, ingredient information may include nutritional facts and chemical composition, food trend data, etc. In the context of itinerary generation, event or place information may include hours of operation, expected time required to see, thematic subject matter, etc. Work plans in the domain knowledge database 108 may be grouped according to classifications, constituents or other characteristics, including combinations of characteristics. The domain knowledge database 108 may further store feedback or other information regarding work plans or combinations of constituents, which may be used by evaluator module 104 in evaluating a new plan. Feedback information may comprise human hedonic perception data and other historical data on quality assessments.

The domain knowledge database 108 may be contained in a database server, cloud storage, networked storage or a physical memory of a server or workstation. Thus, it is to be appreciated that the domain knowledge database 108 shown in FIG. 1 may be implemented on the same or different physical server(s) or workstation(s) as one or more of the constraint modules 106, designer module 102 and evaluator module 104.

The designer module 102 evaluates the existing work plan to determine a set of work plan metrics. For example, if the work plan is a recipe, the work plan metrics may include flavor, cost, ingredient usage, complexity, time required, etc. Various other metrics may be utilized for other types of work plans such as travel itineraries. The constraint modules 106 may provide information relating to one or more constituents to the designer module 102 continuously, in response to a query regarding specific constituents or classes from the designer module 102, at defined time intervals, etc.

If one or more constituents of the existing work plan are subject to a constraint, the designer module 102 can select one or more substitute constituents to replace the constrained constituents. For example, if a particular one of the constraint modules 106 provides information indicating that a given constituent in the work plan has a cost exceeding a threshold, the designer module 102 can use information stored in the domain knowledge database 108 to determine substitutes for the given constituent. The designer module 102 can generate one or more candidate work plans with one or more substitute constituents. The candidate work plans are provided to the evaluator module 104.

The evaluator module 104 utilizes information stored in the domain knowledge database 108 to evaluate the candidate work plans. The evaluator module 104 may calculate a set of work plan metrics for each of the candidate work plans, and compare the calculated metrics for the candidate work plans to the work plan metrics of the existing work plan. A given candidate work plan can be selected which has calculated metrics which are substantially the same or similar to those of the existing work plan.

One or more thresholds or ranges for metrics can be used to determine similarity. By way of example, a cost metric may have an acceptable range of 10%, i.e., the total cost of constituent in the new work plan must be at most 10% more expensive than the total cost of constituents in the existing work plan. Another metric may be related to availability of constituents. The range for the availability metric may be a specified distance, such as 5 miles, where a substitute constituent may be obtained. As will be appreciated by one skilled in the art, various other ranges and thresholds may be utilized, including user-defined thresholds. By way of example the cost threshold may be 5% or 20%, etc. The availability metric may be 1 mile or 10 miles, etc. Various other work plan metrics may be utilized. For example, in the context or recipe generation, metrics such as the olfactory pleasantness or flavor profile of a particular dish may be used. In some embodiments, the metrics for a given work plan may have different weights assigned thereto based on user preferences or context. By way of example, in generating a new recipe the flavor profile and olfactory pleasantness characteristics may be assigned higher weights than a cost metric, or vice versa.

The evaluator module 104 selects one of the candidate work plans as the new work plan. The evaluator module 104 may also determine that none of the candidate work plans are suitable as a new work plan. In such an instance, the work plan metric ranges or thresholds may be adjusted. Alternatively, the evaluator module 104 may request that the designer module 102 generate additional candidate work plans for evaluation. For example, in some embodiments the designer module 102 may initially generate only a small number of candidate work plans so as to ensure quick processing and generation of new work plans. If a situation arises in which none of the originally generated candidate work plans are acceptable, the evaluator module 104 can request the designer module 102 to generate one or more additional candidate work plans. In other embodiments, the designer module 102 and evaluator module 104 may operate substantially simultaneously. For example, the designer module 102 may provide candidate work plan to the evaluator module 104 continuously, or until the evaluator module 104 indicates that a given candidate work plan is acceptable.

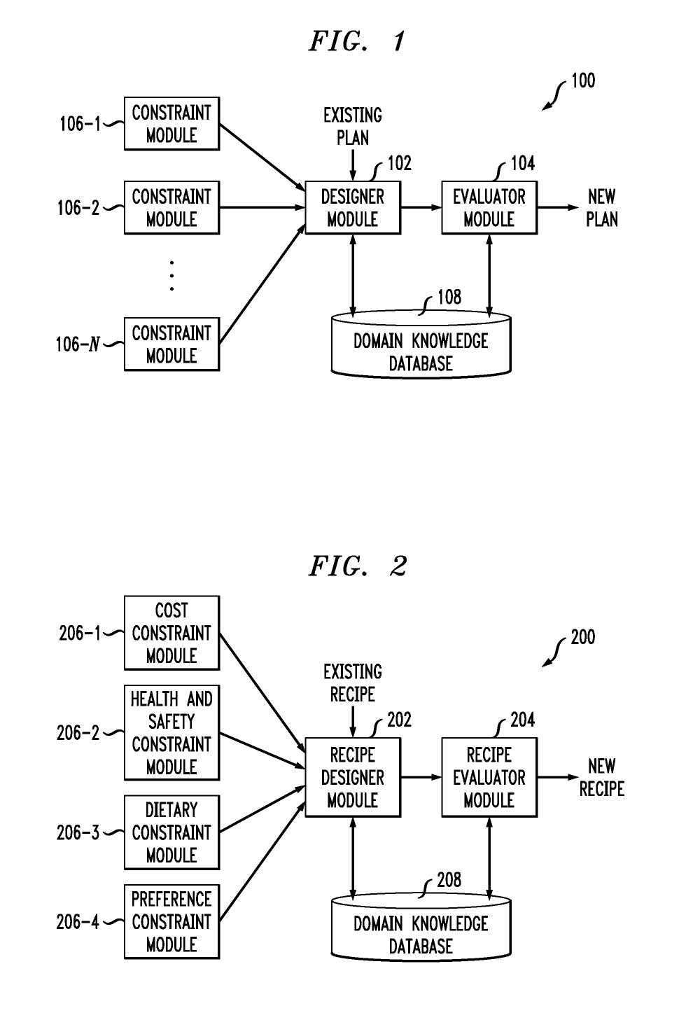

FIG. 2 illustrates a system 200 for recipe analysis and generation. System 200 includes a recipe designer module 202, recipe evaluator module 204, cost constraint module 206-1, health and safety constraint module 206-2, dietary constraint module 206-3, preference constraint module 206-4 and domain knowledge data base 208. The recipe designer module 202 and recipe evaluator module 204 are configured to perform functions similar to those described above with respect to the designer module 102 and evaluator module 104 of system 100. The recipe designer module 202 and recipe evaluator module 204, however, can be specially configured for generation and analysis of recipes. Similarly the constraint modules 206 and domain knowledge database 208 may be configured to perform functions similar to those of the constraint modules 106 and domain knowledge database 108 of system 100.

Cost constraint module 206-1 is configured to provide constraint information relating to the monetary cost and/or availability of ingredients for a recipe. The cost constraint module 206-1 may indicated that a particular ingredient has a higher than average cost at a current time, is subject to shortages due to crop failure or shipping/transportation issues, etc. The cost constraint module 206-1 may also indicate that a particular ingredient is constrained even if its cost is not higher than average if the ease of access or obtaining the constituent is increased. For example, in a rural area, a given ingredient may be difficult to find or obtain, even if it is not more expensive than normal or subject to a shortage.

Health and safety constraint module 206-2 is configured to provide constraint information relating to current food-borne disease outbreaks, medical studies regarding particular ingredients, etc. as discussed above.

Dietary constraint module 206-3 is configured to provide constraint information relating to ingredients with respect to a particular diet. For example, dietary constraints may limit recipes to vegetarian or vegan recipes, kosher or halal recipes, etc. Dietary constraints may also be related to particular weight-loss regimens or plans, such as low-carbohydrate or low-sugar diets, etc. Dietary constraints may also relate to food-borne allergies. For example, a school, hospital or other public facility may wish to screen recipes for common allergens such as peanuts for the safety of consumers.

Preference constraint module 206-4 is configured to provide constraint information relating to user-selected preferences, trend data relating to general consumer preferences, etc. By way of example, user preferences may relate to locally-grown ingredients, organic ingredients, preservative-free ingredients, seasonally-fresh or available ingredients, etc.

Recipe designer module 202 is configured to receive an existing recipe as well as constraint information from constraint modules 206. The recipe designer module 202 can determine that a particular ingredient is subject to one or more constraints, and use information stored in the domain knowledge database 208 to determine substitute ingredients and generate one or more candidate recipes. The recipe designer module 202 can also determine, for a constraint relating to one or more ingredients of the recipe, other ingredients of the recipe which need to be replaced or substituted so as to maintain the set of work plan metrics of the existing recipe.

The recipe evaluator module 204 can calculate metrics such as flavor, cost and ingredient usage of the candidate recipes for comparison with corresponding metrics of the existing recipe so as to select a particular candidate recipe as the new recipe. Additional metrics, such as production process, may also be used. For example, substitute ingredients may be selected such that the overall process of the recipe is not significantly altered (e.g., no new equipment is required, total recipe time is substantially the same, etc.).

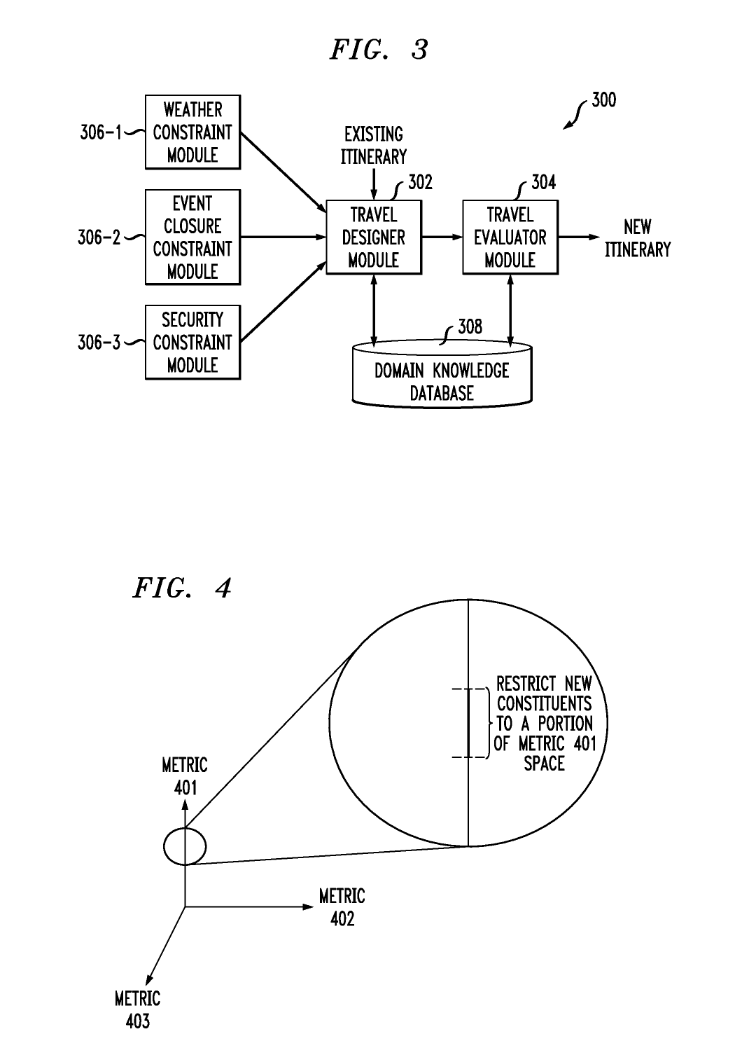

FIG. 3 illustrates a system 300 for itinerary analysis and generation. System 300 includes a travel designer module 302, travel evaluator module 304, weather constraint module 306-1, event closure constraint module 306-2, security constraint module 306-3, and domain knowledge database 308. The travel designer module 302 and travel evaluator module 204 are configured to perform functions similar to those described above with respect to the designer module 102 and evaluator module 104 of system 100. The travel designer module 302 and travel evaluator module 304, however, can be specially configured for generation and analysis of travel itineraries. Similarly, the constraint modules 306 and domain knowledge database 308 may be configured to perform functions similar to those of the constraint modules 106 and domain knowledge database 108 of system 100.

Weather constraint module 306-1 is configured to provide constraint information relating to changing weather conditions for particular geographic regions. The weather constraint module 306-1 may indicate a likelihood of precipitation, temperature range, etc. Travel designer module 302 may use this constraint information to determine that a particular activity scheduled on an agenda or itinerary should be changed or rearranged.

Event closure constraint module 306-2 is configured to provide constraint information relating to the availability of particular events. For example, such information may relate to one or more events which are sold out, particular times during which an event or place is closed, particular times at which an event or place is free or requires a reduced admission fee, etc.

Security constraint module 306-3 is configured to provide constraint information related to security threats, high crime areas, etc.

Travel designer module 302 is configured to receive an itinerary as well as constraint information from constraint modules 306. The travel designer module 302 can determine that a particular event on the itinerary is subject to one or more constraints, and use information stored in the domain knowledge database 308 to determine substitute events or activities and generate one or more candidate itineraries. The travel designer module 302 is further configured to determine, for one or more of the events subject to constraints, other events on the existing itinerary which need to be replaced or adjusted so as to maintain the work plan metrics of the existing itinerary.

The travel evaluator module 304 can calculate metrics such as activity type, cost, and time for the candidate itineraries to compare to corresponding metrics of the existing itinerary so as to select one of the candidate itineraries as the new itinerary. Additional metrics such as location may also be used. For example, it may be desired to restrict replacement events to a particular geographic location so that other events are not affected or to take into account the effects of the geographic location of substitute events on the remainder of an itinerary.

It is to be appreciated that the systems 200 and 300 described above are presented by way of example only. For example while system 300 is described above with respect to travel itineraries, other systems may be used for business schedules, educational schedules, shipping, etc. The system 100 may also be optimized for various other subject areas, including by way of example only the area of fashion (e.g., selecting outfits), the area of construction (e.g., building a structure), etc. In addition, while particular constraint modules 206 and 306 are shown for respective systems 200 and 300, these systems are not restricted solely to use with the particular constraint modules shown.

FIG. 4 illustrates a three-dimensional metric space. As discussed above, existing work plans, candidate work plans and new work plans may have particular metrics associated therewith. These metrics may be modeled in a three dimensional space as shown in FIG. 4 with metric 401, metric 402 and metric 403. Substitute or replacement constituents may be restricted to a particular area of the three-dimensional space to ensure that the new work plan and existing work plan are similar. As shown in FIG. 4, the metric 401 may be restricted to a particular portion of the three-dimensional space. Although not explicitly shown, metrics 402 and 403 may be similarly restricted.

FIG. 5 illustrates a three-dimensional recipe metric space. The recipe metric space may include a flavor metric 501, cost metric 502 and ingredient usage metric 503. As shown in FIG. 5, the flavor metric 501 may be restricted to a particular flavor band. By way of example, the flavor band may limit substitute constituents and new work plans to those that have a given spice or sweetness level, texture, taste, chemical composition, visual appeal, olfactory pleasantness, surprise, etc. The cost metric 502 and ingredient usage metric 503 may be similarly restricted. Other metrics, such as the total number of other constituents affected by the substitute constituent (e.g., constituents in the existing plan which may not be paired with or otherwise incompatible with the substitute constituent) may also be used.

A surprise metric may be used as a measure of the novelty or Bayesian surprise associated with replacement constituents or candidate recipes. In some contexts, users may desire that a replacement recipe or other work plan be familiar. In other contexts, users may desire that a replacement recipe or other work plan be surprising (e.g., new, exciting, etc.). For example, user preference constraints may specify that particular ingredients or constituents be substituted for a desired surprise level or novelty. Novelty may be quantified by considering a prior probability distribution of existing recipes and the change in that probability distribution after a new recipe is observed, i.e., the posterior probability. It is also important to note that the same recipe or work plan may be novel to some observers and familiar to others.

Embodiments may utilize Bayesian surprise to calculate surprise metrics. Let M be a set of work plans known to an observer. Let MεM be a work plan in the set of known work plans, and let A be a new work plan being observed. The Bayesian surprise can be calculated using the following equation:

$$Bayesian surprise = {\int }_{M} p ( M \vert A ) log \frac{p ( M \vert A )}{p ( M )} d M \qquad ( 1 )$$

where p denotes a probability distribution function. It is important to note that while the surprise and novelty metrics are described above primarily with respect to recipe generation, these metrics may be utilized for the generation of various other types of work plans including travel itineraries.

Various other three-dimensional metric spaces may be used for other embodiments. In addition, some embodiments may utilize metric spaces with more or less than three dimensions. One or more metrics of a metric space may also be weighted higher than others. For example, safety metrics may be weighted higher than user preference metrics. In some embodiments, a candidate work plan may be selected if it meets a given portion or percentage of the metrics. For example, if a given work plan has three metrics and thus a three-dimensional metric space, a candidate work plan may be considered similar if two out of three metrics are similar.

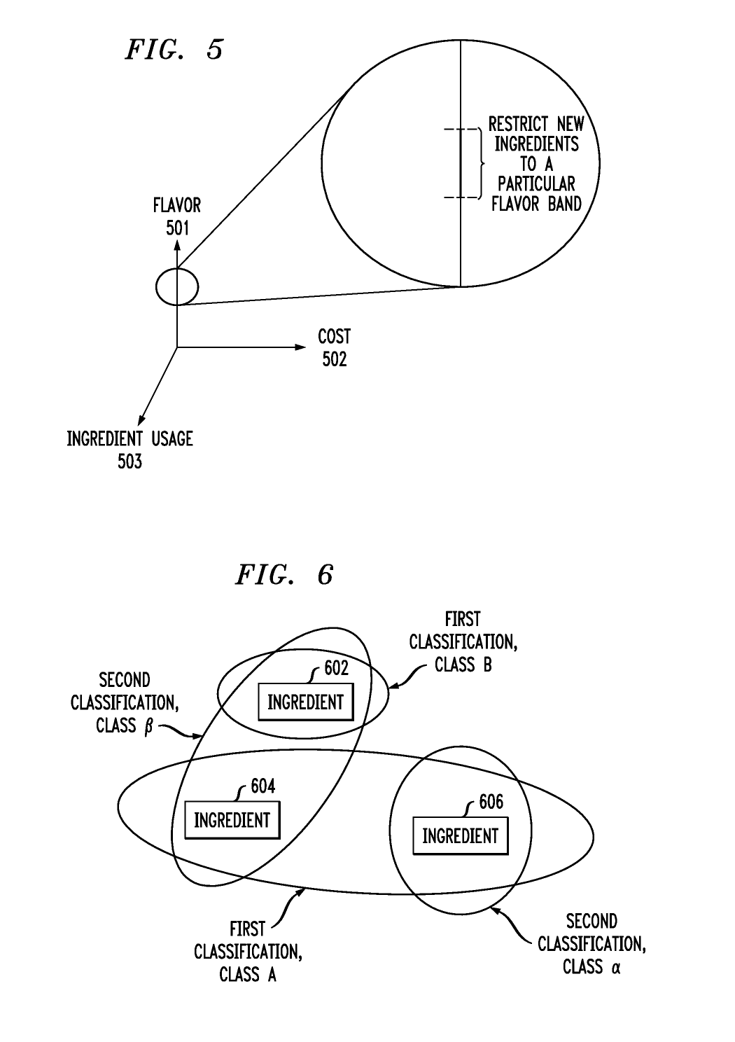

As described above, existing work plans and constituent information in domain knowledge database 108 may be clustered or organized into groups or categories using one or more dimensions. FIG. 6 illustrates an example of ingredient classification for recipes in the domain knowledge database 208 of system 200. FIG. 6 shows ingredients 602, 604 and 606. Each ingredient has first and second classifications. Ingredient 602 has a first classification of class B and a second classification of class β, ingredient 604 has a first classification of class A and a second classification of class β, and ingredient 606 has a first classification of class A and a second classification of class α. While FIG. 6 shows ingredients clustered using two classifications, embodiments are not limited solely to this arrangement. Instead, given ingredients and constituents generally may have more or less than two classifications.

For example, a given ingredient such as ketchup may have a first classification of sweet and a second classification of condiment. An ingredient such as crushed red pepper may have a first classification of spicy and second classification of spice. Classifications may be used to quickly narrow a list of potentially hundreds or thousands of substitute ingredients to a handful of possible substitute ingredients. Classifications may also be used in conjunction with constraints. For example, if a given dietary constraint is for a vegetarian recipe, meat classes may be easily excluded from the space of available substitute ingredients.

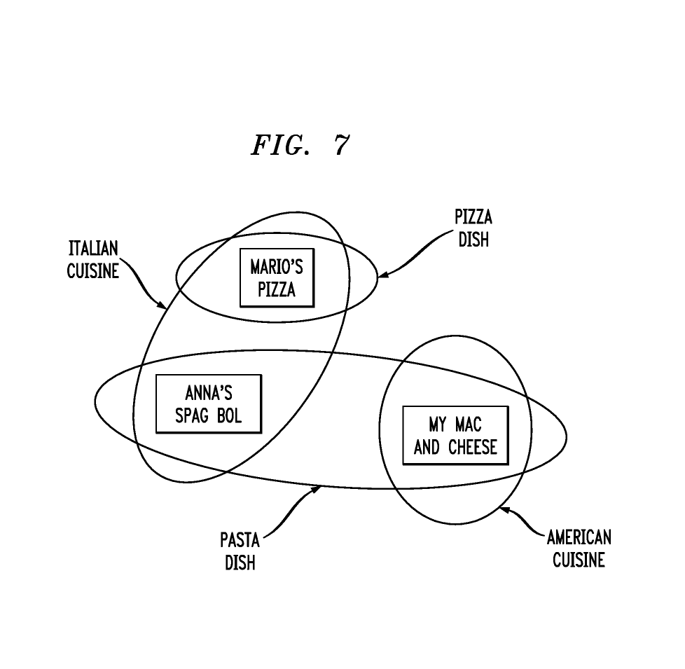

FIG. 7 illustrates an example of recipe classifications in the domain knowledge database 208. FIG. 7 shows three food dishes: Mario's Pizza, Anna's Spag Bol and My Mac & Cheese. Mario's Pizza has a first classification as a pizza dish and a second classification as Italian Cuisine. Anna's Spag Bol has a first classification as a pasta dish and a second classification as Italian Cuisine. My Mac & Cheese has a first classification as a pasta dish and a second classification as American Cuisine. Thus, Mario's Pizza and Anna's Spag Bol form a cluster under their second classification, Italian Cuisine, while Anna's Spag Bol and My Mac & Cheese form a cluster under their first classification, as pasta dishes.

Although FIGS. 6 and 7 show specific examples of ingredient and recipe classification, constituents and work plans generally may be clustered and classified in a similar manner. For example, events and places may be clustered and classified in the context of travel itineraries. Places of attraction may be classified according to the type of place, such as a park, arena, restaurant, museum, monument, art gallery, etc. Events may be similarly classified according to types such as adventure, relaxation, educational, sports, entertainment, etc. Statistical analysis may be used to cluster constituents and work plans into the various classes, as well as determining possible groupings or complements and substitutability of constituents.

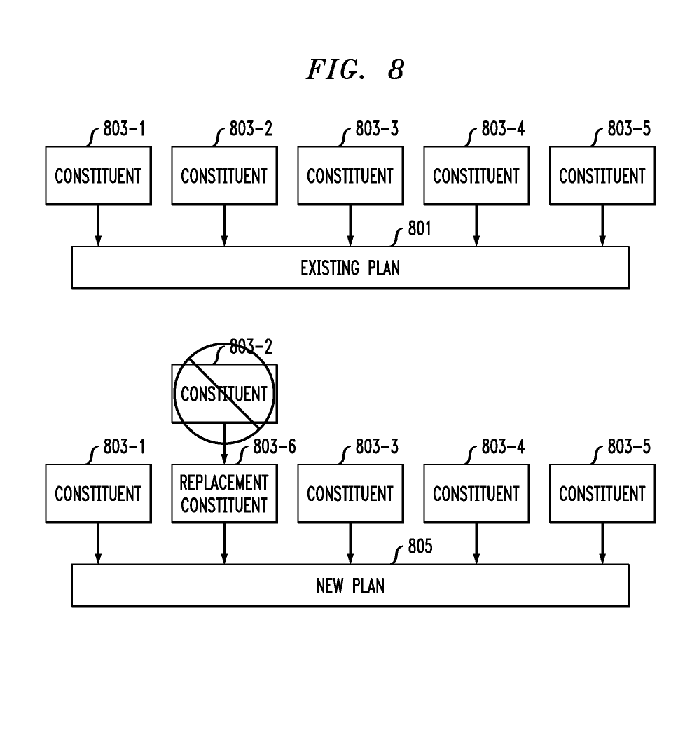

FIG. 8 shows an example of constituent substitution for a work plan. An existing plan 801 utilizes constituent 803-1, constituent 803-2, constituent 803-3, constituent 803-4 and constituent 803-5. On determining that constituent 803-2 is subject to a constraint, the designer module 102 of system 100 will determine a replacement constituent 803-6. Replacement constituent 803-6 may alternatively be referred to as a substitute constituent. As discussed above, the designer module 102 can utilize information stored in domain knowledge database 108 in order to determine a list of possible substitute constituents, with the evaluator module 104 selecting a given one of the possible substitute constituents as the replacement constituent 803-6 for new plan 805. The evaluator module 104 can select the given substitute constituent as the replacement constituent 803-6 such that the existing plan 801 and new plan 805 have similar sets of work plan metrics.

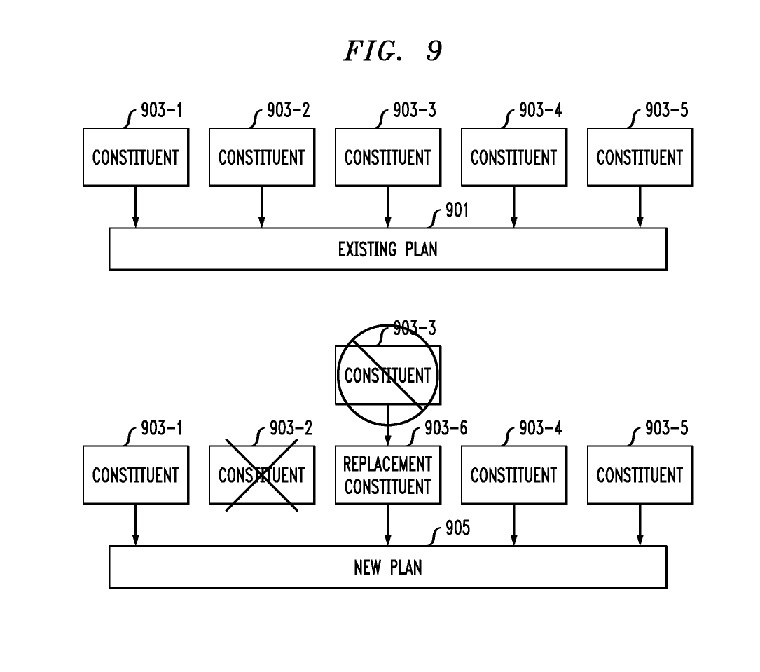

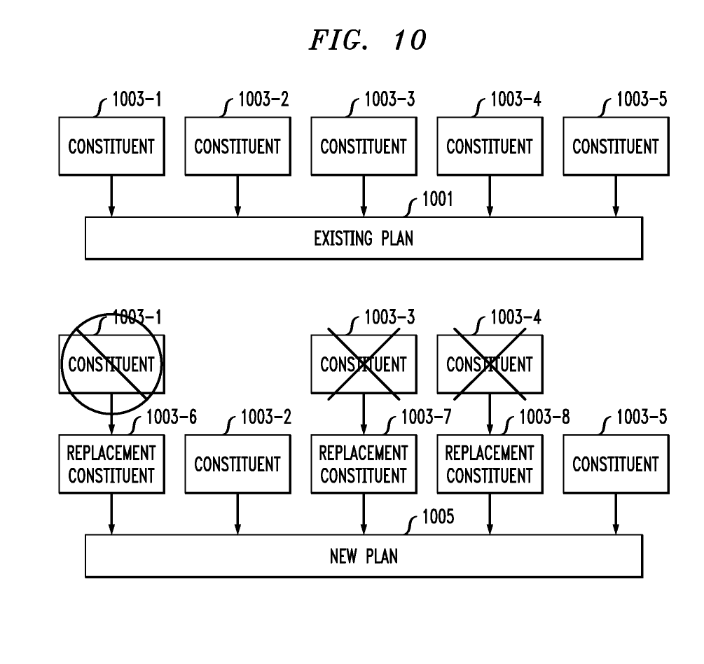

FIG. 9 shows another example of constituent substitution for a work plan. Existing plan 901 utilizes constituent 903-1, constituent 903-2, constituent 903-3, constituent 903-4 and constituent 903-5. In the FIG. 9 example, constituent 903-3 is determined to be subject to one or more constraints. Replacement constituent 903-6 is selected as a substitute for constituent 903-3. However, as shown in FIG. 9, when substituting replacement constituent 903-6 for constituent 903-3, constituent 903-2 is also removed in the new plan 905. This may occur because of interrelationships among constituent 903-2 and constituent 903-3, or due to incompatibilities of redundancies between constituent 903-2 and replacement constituent 903-6.

In recipe analysis, certain ingredients in a food recipe may not pair well with one another, so if one of the ingredients in an existing recipe is substituted for a replacement ingredient in a new plan, other adjustments to ingredients of the existing recipe may be necessary. For example, if one were to substitute soy milk for milk in an existing recipe, other ingredients (e.g., vanilla) may need to be removed and/or reduced so as to maintain a particular sweetness flavor profile. In addition, the replacement of a given ingredient may make one or more other ingredients redundant, or require the addition of one or more other ingredients. As an example, one may replace heavy cream in certain recipes with a combination of milk and butter, or vice versa.

In travel itinerary analysis, certain events in an itinerary may similarly conflict with one another. On determining that a given event is constrained due to weather, a replacement event may require adjustments to other parts of an itinerary. For example, assume that an event at a zoo is constrained due to weather and replaced with a natural history museum event. The zoo and natural history museum may be in very different locations, such that a lunch or dinner reservation may be adjusted to a restaurant or eatery closer to the natural history museum than the zoo.

FIG. 10 shows a further example of constituent substitution for a work plan. Existing plan 1001 utilizes constituent 1003-1, constituent 1003-2, constituent 1003-3, constituent 1003-4 and constituent 1003-5. In the FIG. 10 example, constituent 1003-1 is determined to be subject to one or more constraints. Replacement constituent 1003-6 is selected as a substitute for constituent 1003-1. Substituting replacement constituent 1003-6 for constituent 1003-1, however, also necessitates the replacement of constituent 1003-3 and constituent 1003-4 which are not subject to one or more constraints. Constituent 1003-3 is substituted with replacement constituent 1003-7 and constituent 1003-4 is substituted with replacement constituent 1003-8 in new plan 1005.

It is important to note that FIGS. 8-10 illustrate only three specific examples of constituent substitution in work plans. Embodiments, however, are not limited solely to the specific examples shown in FIGS. 8-10. For example, in some instances two or more constituents of an existing plan may be subject to constraints. In addition, substitute constituents are not always performed on a one-to-one basis. For example, two or more constituents may in some contexts be replaced with a single constituent, or a single constituent may be substituted for two or more replacement constituents.

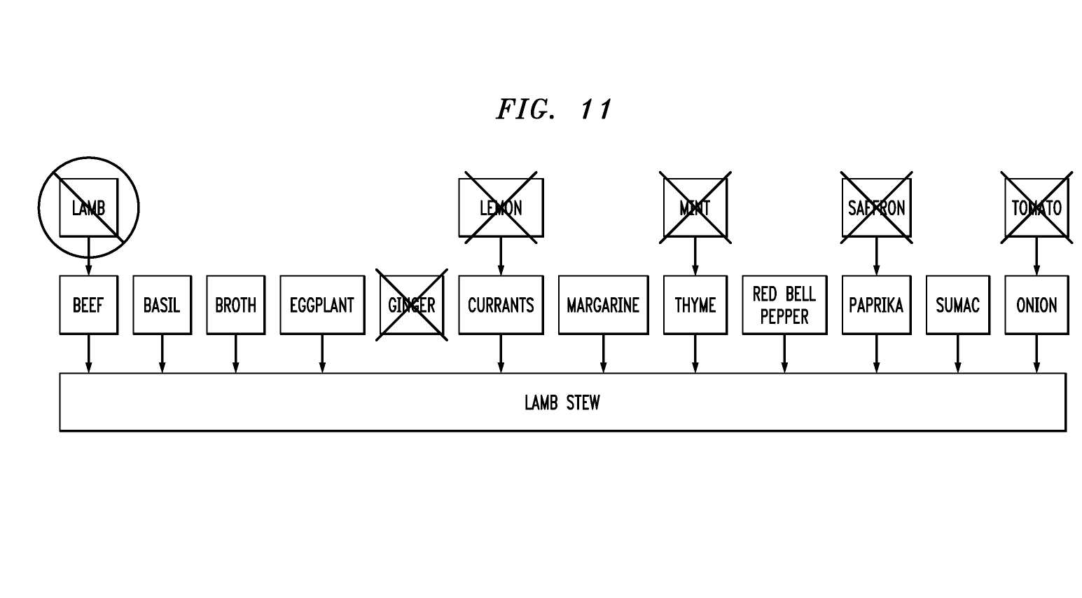

FIG. 11 shows a specific example of ingredient substitution for a recipe. The existing recipe is one for a Turkish-style lamb stew, and includes the ingredients of lamb, basil, broth, eggplant, ginger, lemon, margarine, mint, red bell pepper, saffron, sumac and tomato. In the FIG. 11 example, lamb is subject to one or more constraints. If beef is selected as a substitute for lamb as shown in FIG. 11, adjustments to other ingredients in the recipe for lamb stew are also required. For example, beef may not pair well with ginger, lemon, mint, saffron and tomato. The combination of lemon, mint, saffron and tomato may be replaced by the combination of currants, thyme, paprika and onion. Ginger may be dropped from the new recipe altogether.

Because of the various interrelationships of ingredients, in many cases a simple one-for-one substitution will not retain existing work plan metrics. It is important to note that substitutions of constituents need not necessarily be considered “equivalent.” In the FIG. 11 example above, substitution of thyme for mint and currants for lemon will have an impact of the recipe for lamb stew (i.e., these are not perfect substitutes with a same flavor profile). Instead, in the FIG. 11 example, the individual substitutions when combined with one another can maintain certain metrics of the original recipe such as the overall olfactory pleasantness and taste. In the FIG. 11 example, the substitute ingredients pair better with beef, are commonly used in Turkish dishes, maintain the basic nature of the dish (i.e., a fruit is replace by another fruit, an herb is replace by another herb, a spice is replaced with another spice and a vegetable is replaced with another vegetable). The flavor profiles of the existing lamb stew and the generated beef stew recipe will be different but the metrics associated with the two dishes may be substantially the same. In other embodiments, substitution of ingredients may be selected such that a particular flavor profile of the existing recipe is maintained in newly generated recipes.

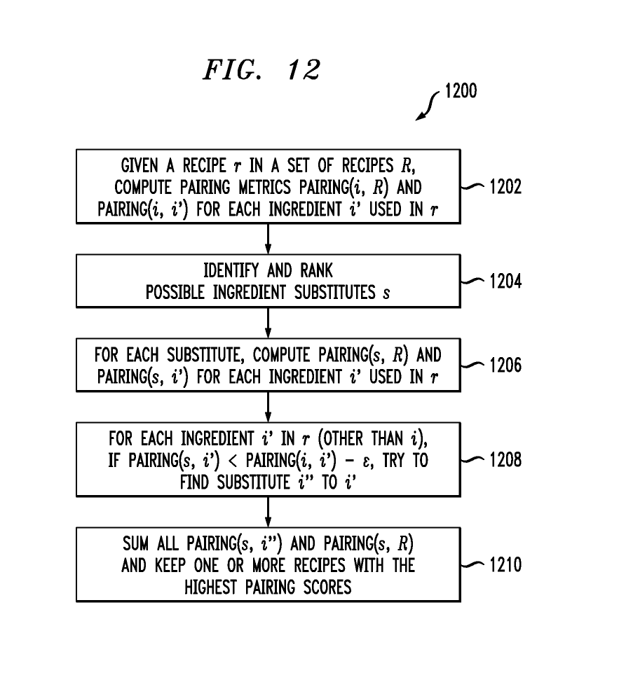

FIG. 12 illustrates a methodology 1200 for determining a recipe with substitute ingredients. It is important to note, however, that the methodology 1200 can be readily adapted for use in determining travel itineraries with substitute events and a variety of other work plans with substitute constituents. In the methodology 1200, r is a recipe belonging to a cluster R. For example, the recipe r may be lamb stew while the cluster R may be stew recipes. An ingredient in the recipe r is denoted i, with an associated cluster I. As an example, ingredient i may be beef, with cluster I being meat. i′ denotes another ingredient in the recipe r. Pairing(i, R) denotes a frequency of occurrence of the ingredient i in recipes belonging to cluster R, or the number of recipes in R that use i divided by the total number of recipes in R. Pairing (i, i′) denotes a frequency of occurrence of ingredients i and i′ together, or the total number of recipes that contain both i and i′ divided by the total number of recipes that contain i′. Variations of the pairing functions may also be utilized in embodiments of the invention. By way of example, pairing(i, i′) may instead denote a frequency of occurrence of ingredients i and i′ in cluster R only.

Methodology 1200 begins with step 1202, computing pairing metrics pairing(i, R) and pairing(i, i′) for each ingredient i′ used in r, given a recipe rεR. Next, possible substitute ingredients s for ingredient i are identified and ranked in step 1204. For each substitute s, pairing metrics pairing(s, R) and pairing(s, i′) are computed for each ingredient i′ used in r in step 1206. In step 1208, for each ingredient i′ in r (other than i), if pairing(s, i)<pairing(i, i′)−ε the methodology tries to find a substitute i″ to i′ and repeats steps 1206 and 1208 with i″ instead of s. The value ε may represent a threshold value or metric space which defines similarity. For example, ε may be selected so as to correspond to the desired flavor band as discussed above with respect to FIG. 5.

Pairing metrics pairing(s, i″) and pairing(s, R) are summed in step 1210. One or more recipes with the highest pairing scores as determined in step 1210 are selected as candidate recipes. A new recipe may be selected from the set of candidate recipes based on additional evaluation criteria, such as cost, surprise, similarity of cooking method, etc. Alternatively, only a single recipe may be selected in step 1210.

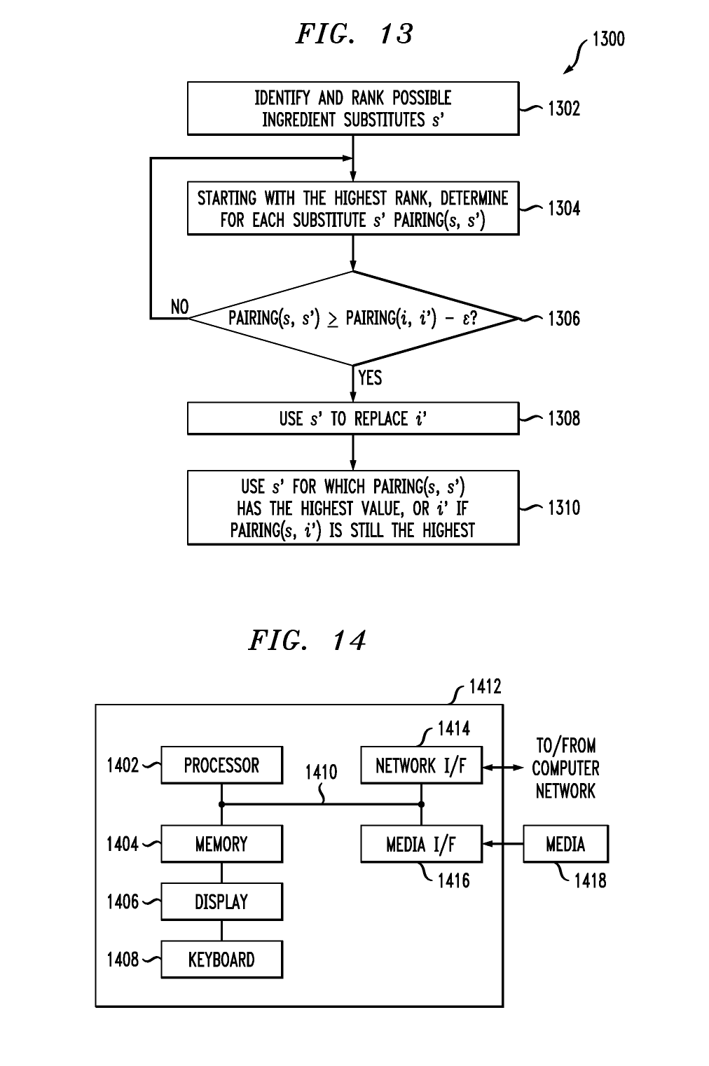

Step 1204 of methodology 1200, identifying and ranking possible substitute ingredients s in step 1204, may be performed using methodology 1300 as shown in FIG. 13. To identify and rank possible substitutes to an ingredient iεI, one can first choose all the ingredients in I. In other embodiments, a particular number of ingredients in I may be selected. Ingredients from a class I′ which is similar to I may also be added to the possible substitute ingredient space. In some instances, clusters of ingredients can be considered similar enough that ingredients in two or more clusters are suitable substitutes for one another. By way of example, similar clusters may include fish and meat, vegetables and fruit, etc. Similarity among clusters can be determined by structural or flavor equivalence. Ingredients in the substitute space may be ranked according to one or more criteria, including: by decreasing number of flavor compounds or characteristics in common with ingredient i, by decreasing value of pairing metric pairing(s, R), by decreasing number of recipes r′ that are the same dish as r but do not use i, cost, availability, combinations of the above criteria, etc.

FIG. 13 illustrates the methodology 1300. Methodology 1300 begins with step 1302, where a substitute s is chosen, and possible substitute ingredients s′ are identified and ranked. In step 1304, starting with the highest ranking substitute s′, the pairing metric pairing(s, s′) is determined for substitute s′. Next, a determination is made in step 1306 as to whether the pairing metric pairing(s, s′)≧pairing metric pairing(i, i′)−ε. If pairing(s, s′)≧pairing(i, i′)−ε, methodology 1300 continues to step 1308. Otherwise, methodology 1300 returns to step 1304, where the pairing metric pairing(s, s′) is determined for the next highest ranking substitute. The determination in step 1306 is repeated until pairing(s, s′)≧pairing(i, i′)−ε or another designated stopping criterion is met. For example, methodology 1300 may only repeat the determination in step 1306 for the x highest ranking substitutes s′.

If pairing(s, s)≧pairing(i, i′)−ε, s′ is used to replace ingredient i′ in step 1308. If the determination in step 1306 has met is stopping criterion and no substitute s′ is found where pairing(s, s′)≧pairing(i, i′)−ε, the methodology proceeds to step 1310. In step 1310, the substitute s′ is used for which the pairing metric pairing(s, s′) has the highest value or the ingredient i′ is used if the pairing metric pairing(s, i′) is higher than pairing(s, s′).

A method according to an embodiment of the invention may include evaluating a first or existing work plan having one or more constituents to determine a first set of work plan metrics associated with the first work plan. One or more constraints for constituents of the first work plan are determined, and one or more substitute constituents are selected to replace constituents of the first work plan. The substitute constituents may be selected based on the determined constraints and the work plan metrics associated with the first work plan. A second or new work plan is generated using the substitute constituents such that the second work plan has a second set of work plan metrics associated therewith which are similar to the first set of work plan metrics.

Selecting the substitute constituents may involve the following. First, a given constituent which is subject to at least one constraint is selected. Next, one or more alternate or replacement constituents are determined for the given constituent. For each of the alternate constituents, one or more associated replacement constituents are determined for constituents of the first work plan other than the given constituent such that the alternate constituent and associated replacement constituents maintain the first set of work plan metrics. A given alternate constituent and associate replacement constituents are selected as the substitute constituents.

The given alternate constituent and associated replacement constituents may be selected based on a number of factors, including but not limited to a cost of the given alternate constituent and associated replacement constituents, the number of associated replacement constituents, an availability of the alternate constituent and associated replacement constituents, a surprise associated with the given alternate constituent and associated replacement constituents, combinations of the above factors, etc.

Determining the alternate constituents may include analyzing the given constituent to determine one or more attributes, such as clusters with which the given constituent is associated. A knowledge database can be searched to determine alternate constituents having attributes similar to the attributes of the given constituent. The alternate constituents may additionally or alternatively be determined by identifying a class or cluster associated with the first work plan, identifying a set of constituents or one or more other work plans in the given class, and selecting alternate constituents from the identified set of constituents. As another alternative or in addition to the techniques described above, determining the alternate constituents may include identifying a set of constituents, determining a substitutability metric of each constituent in the identified set, ranking the constituents in the identified set based at least in part on the determined substitutability metrics, and selecting one or more constituents in the identified set based on the constituent rankings.

It is to be appreciated that particular features described above with respect to a particular embodiment of the invention are not necessarily limited solely to use in the particular embodiment described. Instead, a single embodiment may include features described above in the context of two or more different embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more embodiments can make use of software running on a general purpose computer or workstation. With reference to FIG. 14, such an implementation may employ, for example, a processor 1402, a memory 1404, and an input/output interface formed, for example, by a display 1406 and a keyboard 1408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to optionally include, for example, one or more mechanisms for inputting data to the processing unit (for example, keyboard or mouse), and one or more mechanisms for providing results associated with the processing unit (for example, display or printer).

The processor 1402, memory 1404, and input/output interface such as a display 1406 and keyboard 1408 can be interconnected, for example, via bus 1410 as part of data processing unit 1412. Suitable interconnections, for example, via bus 1410, can also be provided to a network interface 1414, such as a network card, which can be provided to interface with a computer network, and to a media interface 1416, such as a diskette or CD-ROM drive, which can be provided to interface with media 1418.

A data processing system suitable for storing and/or executing program code can include at least one processor 1402 coupled directly or indirectly to memory elements 1404 through a system bus 1410. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboard 1408 for making data entries; display 1406 for viewing data; a pointing device for selecting data; and the like) can be coupled to the system either directly (such as via bus 1410) or through intervening I/O controllers (omitted for clarity).

Network adapters such as a network interface 1414 may also be coupled to the system to enable the data processing system to become coupled to other data processing systems or remote printers or storage devices through intervening private or public networks. Modems, cable modem and Ethernet cards are just a few of the currently available types of network adapters.

As used herein, a “server” includes a physical data processing system (for example, system 1412 as shown in FIG. 14) running a server program. It will be understood that such a physical server may or may not include a display and keyboard. Further, it is to be understood that components may be implemented on one server or on more than one server.

The flowchart and block diagrams in FIGS. 1-14 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Accordingly, techniques of the invention, for example, as depicted in FIGS. 1-14, can also include, as described herein, providing a system, wherein the system includes distinct modules (e.g., modules comprising software, hardware or software and hardware).

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention. The terminology used herein was chosen to best explain the principles of the embodiments, the practical application or technical improvement over technologies found in the marketplace, or to enable others of ordinary skill in the art to understand the embodiments disclosed herein.

1. A method comprising:
evaluating a first work plan comprising one or more constituents to determine a first set of work plan metrics;
determining one or more constraints for constituents of the first work plan;
selecting one or more substitute constituents to replace constituents of the first work plan based at least in part on the determined constraints and the determined work plan metrics; and
generating a second work plan using the substitute constituents, the second work plan having a second set of work plan metrics similar to the first set of work plan metrics;
wherein the evaluating, determining, selecting and generating are performed by at least one processing device.

2. The method of claim 1, wherein selecting one or more substitute constituents comprises:
selecting a given constituent subject to at least one of the determined constraints;
determining one or more alternate constituents for the given constituent;
for each of the alternate constituents, determining constituents of the work plan other than the given constituent to be removed or replaced with one or more associated replacement constituents to maintain the first set of work plan metrics; and
selecting a given alternate constituent and associated replacement constituents as the substitute constituents.

3. The method of claim 2, wherein selecting the given alternate constituent and associated replacement constituents is based at least in part on a cost of the given alternate constituent and associated replacement constituents.

4. The method of claim 2, wherein selecting the given alternate constituent and associated replacement constituents is based at least in part on the number of associated replacement constituents.

5. The method of claim 2, wherein selecting the given alternate constituent and associated replacement constituents is based at least in part on an availability of the alternate constituent and associated replacement constituents.

6. The method of claim 2, wherein determining the alternate constituents comprises:
analyzing the given constituent to determine one or more attributes;
searching a knowledge database of constituents to determine alternate constituents having attributes similar to the attributes of the given constituent.

7. The method of claim 2, wherein determining alternate constituents further comprises:
determining a given class associated with the first work plan;
identifying a set of constituents of one or more other work plans in the given class; and
selecting the alternate constituents from the identified set of constituents.

8. The method of claim 2, wherein determining alternate constituents further comprises:
identifying a set of constituents;
determining a substitutability metric of each constituent in the identified set;
ranking the constituents in the identified set based at least in part on the determined substitutability metrics; and
selecting one or more constituents in the identified set based on the constituent rankings.

9. The method of claim 1, wherein evaluating the first work plan further comprises determining an acceptable range of values for the first set of metrics, the second set of metrics being in the acceptable range of values.

10. The method of claim 1, wherein the one or more constraints comprise at least one of an increase in the cost of one or more constituents and a shortage in the availability of one or more constituents.

11. The method of claim 1, wherein the one or more constraints comprise one or more user-defined constraints.

12. The method of claim 1, wherein the one or more constraints comprise a medical or health restriction relating to the one or more constituents.

13. The method of claim 1, wherein generating the second work plan further comprises generating the second work plan and one or more additional work plans having respective sets of work plan metrics similar to those of the first set of work plan metrics.

14. The method of claim 1, wherein the first work plan and the second work plan comprise respective food recipes.

15. The method of claim 14, wherein the first set of metrics comprises:
at least one of chemistry, texture, taste, visual appeal and olfactory pleasantness; and
at least one of caloric value, nutrient value and financial cost.

16. The method of claim 1, wherein the first work plan and the second work plan comprise respective travel itineraries.

17-20. (canceled)
